(19) United States
(12) Patent Application Publication
(10) Pub. No.: US 2020/0281194 A1
(43) Pub. Date: Sep. 10, 2020

(54) A Novel Green Micro-Emulsion for Controlling Fungal Wilt Diseases

(71) Applicants: Indian Institute of Technology, Delhi, New Delhi (IN); Secretary, Department of Biotechnology, New Delhi (IN)

(72) Inventors: Satyawati Sharma, New Delhi (IN); Abhishek Sharma, New Delhi (IN); Saurabh Dubey, New Delhi (IN); S. N. Naik, New Delhi (IN)

(21) Appl. No.: 16/645,529

(22) PCT Filed: Sep. 7, 2018
(86) PCT No.: PCT/IB2018/056823

§ 371 Date: Mar. 9, 2020

(30) Foreign Application Priority Data
Sep. 7, 2017 (IN) 201711031634

(51) Int. Cl. A01N 25/04; A01N 65/28; A01N 65/44; A01N 65/22; A01N 65/48; A01N 65/12; A01N 65/26; A01N 65/18; A01N 65/24

(52) U.S. Cl. CPC A01N 25/04; A01N 65/28; A01N 65/44; A01N 65/22; A01N 65/24; A01N 65/12; A01N 65/26; A01N 65/18; A01N 65/48

(57) ABSTRACT

The present invention relates to an antifungal oil-in water microemulsion formulation comprising two different bioactive ingredients which are lipophilic (essential oils) and hydrophilic (plant biomass aqueous extracts) in nature, but reside in different phases of the said microemulsion. In particular, the present invention provides a liquid microemulsion comprising a synergistic mixture of two essential oils as the active ingredient in the dispersed phase and a hydrophilic biomass aqueous extract in continuous phase that not only facilitates the overall antifungal efficacy of the microemulsion but also maintains its potency against wilt inducing fungus F. oxysporum during storage.

### FIELD OF THE INVENTION

The present invention relates to development of anti-fungal botanical based micro-emulsion formulation that comprises essential oils in dispersed phase and an aqueous plant biomass extract in continuous phase.

### BACKGROUND OF THE INVENTION

Wilt diseases is one of the most widespread and destructive diseases occurring in many major ornamental and horticultural crops. Fusarium wilt is a fungal disease caused primarily by Fusarium oxysporum and it infects, among others, tomatoes and legume crops. Annual losses of up to 10-15% of the crop damage are associated with Fusarium wilt of tomato. These soil-borne fungi cause vascular wilts by infecting plants through the roots and growing internally through the cortex to the stele. The vascular tissues of the root, and then the stem, are colonized by growth of hyphae and movement of conidia in the transpiration stream. Initial symptoms appear as chlorosis and distortion of the lower leaves, often on one side of the plant. Foliar chlorosis, necrosis, and plant stunting become more pronounced as the disease progresses. Wilting occurs on the affected side of the plant, followed by vascular discoloration and stem necrosis. The entire plant wilts and dies as the pathogen moves into the stem. F. oxysporum, plays the role of a silent assassin—the pathogenic strains of this fungus can be dormant for 30 years before resuming virulence and infecting a plant. The pathogen is primarily spread over short distances by irrigation water and contaminated farm equipment but can also be spread over long distances either in infected transplant or soil. The disease or infection can also be transmitted through infected plant material and through contaminated soil. Other means of spreading the disease is through human movement around the infected field, or the use of irrigation water and implements previously used on an infected crop.

Currently, diseases which attack horticulture crops are controlled using commercial fungicides (Mancozeb, carbendazim, carboxin etc.). It is obvious that the wide use of agrochemical treatments for pest control leads to some deleterious effects on most of the ecosystems and non-target organisms. Also, long-term extensive fungicides in open field have led to the appearance of fungicide-resistant populations of fungal pathogens. Due to the hazard and toxic effects of agrochemicals, an alternative or natural method should be used in plant protection. Plants produce a number of secondary metabolites which have antimicrobial activity against a wide range of micro-organisms. Therefore, the formulation of these metabolites must be introduced to overcome their degradation and to be used practically during handling and application as biopetsicides.

European Patent (EP 2826372 A1) relates to the use of an essential oil and/or a supercritical extract, both of which are taken from the Artemisia absinthium L plant populations in Teruel and/or the Sierra Nevada, as a fungicide, i.e., to control phytopathogenic fungi in agricultural crops. Bowers and Locke (2000) stated that several commercial formulations of botanical extracts and essential oils were being investigated as possible alternatives to soil fumigation for control of Fusarium wilt diseases. Seoud et al. (2005) discloses the antimicrobial activities (including fungicidal activity against F. oxysporum) of different plant essential oils and a biocide formulation prepared from these essential oils with the aid of emulsifiers. Abd-Elsalam and Khokhlov (2015) reported oil-in-water nanoemulsion of eugenol against F. oxysporum. Biofumigation by means of Brassicaceae green manure or seed meal incorporation into soil is another promising, environmentally friendly alternative to chemical fumigation by methyl bromide for the control of soil-borne pathogens. This biological approach is based on the release of glucosinolate-derived toxic compounds, mediated by endogenous myrosinase (E.C. 3.2.1.147) from Brassicaceae disrupted tissues or seed meals, in the presence of water (Brown and Morra, 1997).

Although prior arts disclose the development and deployment of plant derived products to target soil borne pathogens, there remain certain drawbacks such as the efficacy of these materials falls short when compared to synthetic pesticides and also require somewhat greater application rates and may require frequent reapplication when used in field. Therefore, in order to harness these green/herbal products to their full potential there are several avenues that have to be explored, primarily the use of combinations of plant products (essential oils, plant extracts etc.).

Abhishek Sharma et. al.: Journal of Bioscience and Bioengineering, 2016 discloses antifungal effects of four essential oils viz., clove (Syzygium aromaticum), lemongrass (Cymbopogon citratus), mint (Mentha piperita) and eucalyptus (Eucalyptus globulus) oils that were evaluated against the wilt causing fungus F. oxysporum. Among all these selected oils, clove oil showed maximum antifungal activity and hence it was selected for the development of oil-in-water nanoemulsion formulation. The stability test conducted revealed the shelf life of formulation to be two years with MIC of 0.4%. However, the continuous phase of the nano-emulsion is distilled water and is devoid of any active ingredients. Imaël Henri Nestor Bassolé et. al.: Molecules 2012, 17, 3989-4006 discloses use of combinations of EOs as a new approach towards increasing the antimicrobial efficacy of EOs in foods, taking advantage of their synergistic and additive effects. The purpose of this review is to provide an overview on the antimicrobial efficacy of these combinations. A survey of the methods used for the determination of the interactions and mechanisms involved in the antimicrobial activities of these combinations are also reported.

Nasreen Sultana et. al.: Pak. J. Bot., 45(6): 2149-2156, 2013 discloses fungicides, microbial antagonists and oil cakes that were used in vitro and in vivo to control Fusarium oxysporum, in bottle gourd and cucumber. In this study, mustard oil cake amendment in soil significantly controlled the seed borne diseases. Mustard cake supplemented at high ratio reduced seedling mortality caused by F. oxysporum and markedly increased germination in bottle gourd and cucumber. However, it does not disclose development of a microemulsion formulation comprising aqueous mustard cake in the continuous phase.

Therefore, there is still a need in the art to develop a process for preparing an emulsion wherein both lipophilic (essential oils) and hydrophilic (plant biomass aqueous extracts) active ingredients are incorporated together in one o/w formulation but in different phases.

### OBJECTIVES OF THE INVENTION

It is an objective of the present invention to overcome the drawbacks of the prior arts.

It is another objective of the present invention to develop an oil-in water microemulsion comprising essential oils as active ingredient in dispersed phase and plant biomass aqueous extract as active ingredient in continuous phase.

It is another objective of the present invention to provide a microemulsion comprising a combination of two synergistic essential oils (clove and lemongrass oil) in a defined concentration ratio of 1:1 in the dispersed phase.

It is another objective of the present invention to prepare an oil-in-water microemulsion wherein the continuous phase contains an aqueous extract of a bioactive ingredient selected from edible oil cakes, non-edible oil cakes or herbs.

It is yet another objective of the invention to provide an oil-in-water microemulsion comprising two synergistic essential oils in dispersed phase and active aqueous extract of mustard cake in continuous phase that is effective against F. oxysporum in tomato plants.

### SUMMARY OF THE INVENTION

In one aspect the present invention, it provides an antifungal oil-in-water microemulsion formulation comprising a) 2.5-5 wt. % of a mixture of lipophilic bioactive ingredients in dispersed phase; b) 18-57 wt. % of a plant biomass aqueous extract in continuous phase of distilled water; and c) 5-20 wt. % of an amphiphilic surfactant.

In another aspect of the present invention, it provides an antifungal microemulsion formulation comprising a) 2.5-5 wt. % of a mixture of two essential oils at a ratio of 1:1 in dispersed phase; b) 18-57 wt. % of a plant biomass aqueous extract in continuous phase of distilled water; and c) 5-20 wt. % of an amphiphilic surfactant.

In a further aspect of the present invention, it provides a fungicidal composition comprising 1394 ppm to 4000 ppm amount of the oil-in-water microcinulsion formulation as developed in the present invention.

### BRIEF DESCRIPTION OF ACCOMPANYING DRAWINGS

FIG. 1 illustrates the effect of composition D on mycelia growth of wilt fungus, F. oxysporum before and after accelerated storage condition (15 days at 40° C. & 70% Relative Humidity (RH). The graph revealed that MIC value for the formulation is 4000 ppm. Microemulsion formulation remained almost stable after 15 days and inhibited 94.5% of fungal growth.

FIG. 2 illustrates the effect of composition B on mycelia growth of wilt fungus, F. oxysporum before and after accelerated storage condition (15 days at 40° C. & 70% RH). The graph revealed that MIC value for the formulation is 6000 ppm. Microemulsion formulation inhibited 83.5% of fungal growth after 15 days suggesting loss of potency after storage.

FIG. 3 illustrates Fusarium oxysporum spore reduction (%) during time by using minimum inhibition concentrations of composition B and D ( . . . Eq. (2)). The kinetic model revealed 1.33 times faster fungicidal activity of composition D comparing to B.

FIG. 4 illustrates the effect of Microemulsion formulation at various doses (MIC, IC90 and IC50) and chemical (Carbendazim @0.1%) on disease reduction (%) of FOL

### DETAILED DESCRIPTION OF INVENTION

The following description with reference to the accompanying drawings is provided to assist in a comprehensive understanding of exemplary embodiments of the invention. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise.

Features that are described and/or illustrated with respect to one embodiment can be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

The present invention relates to a fungicidal composition comprising bioactive ingredients from the plants which are both lipophilic (essential oils) and hydrophilic (plant biomass aqueous extracts) in nature, but residing in different phases of the emulsion. The composition is further characterized in that it is formulated as an oil-in water microemulsion.

Microemulsions are homogenous, transparent, and thermodynamically stable dispersions of oil and water stabilized by a surfactant, usually in combination with co-surfactant with a droplet size typically in the range of 10-100 nm. In terms of its rheological properties, a microemulsion may be in the form of a liquid or a gel, i.e. in liquid or semisolid form.

In a preferred embodiment of the present invention, the microemulsion is in liquid form. The preparation of microemulsion usually involves low-energy emulsification method. In the present invention, the lipophilic bioactive ingredients in dispersed phase of the microemulsion are plant essential oils. These hydrophobic essential oils (EO), or aromatic plant essences, are volatile and fragrant substances with an oily consistency especially produced by plants, which mainly include biosynthetically related groups such as terpenes, terpenoids, aromatic and aliphatic constituents. Thus the biological activities of EOs can be lost by volatilization of active components or its degradation by act of high temperatures; oxidation and UV light. These disadvantages make the commercial application of these oils limited. Another major drawback with EOs is their sparing solubility in aqueous phases. Hence, the concentration of these hydrophobic antimicrobials is low in solvent phase where pathogens inhabit. Accordingly, it is required to formulate these EOs into water soluble liquid forms (emulsions, micelles etc.), intended to be employed for controlled release of active ingredients and protecting them from the external environment. Further, the use of combinations, either from whole EOs or artificial mixtures of purified main components aims to increase the efficacy of the essential oil by taking advantage of the synergistic and additive properties that these components can exhibit.

The lipophilic components in the dispersed phase of the microemulsion are selected on the basis of their synergistic performance against fungal wilt pathogen i.e. F. oxysporum. These components are chosen from a group of essential oils consisting of clove oil, lemon grass oil, mint oil, thyme oil, eucalyptus oil, ginger oil, sesame oil, basil oil, geranium oil, rosemary oil, lavender oil, marigold oil, preferably clove oil and lemongrass oil. Further, in such synergistic mixture, clove oil and lemongrass oil is present in a ratio of 1:1.

As particularly used in the present invention, cloves (Syzygium aromaticum) are the aromatic flower buds of a tree in the family Myrtaceae while Cymbopogon, better known as lemongrass, is a genus of Asian, African, Australian, and tropical island plants in the grass family. The chemical analyses carried out show a specific qualitative and quantitative composition of the EOs obtained from these plants.

Eugenol (75.41%) is the major compound in clove essential oil while Citral-a (32.80%) and Citral-b (30.35%) ae the most abundant in lemongrass oil. Clove and lemongrass oil in the microemulsion formulation of the current invention is specifically present in 1:1 ratio in the dispersed phase. The total content of the mixture of EOs ranges from 2.5-5 wt % and more preferably the composition comprises of 5 wt % EO mixture.

The anti-fungal efficacy studies of the present microemulsion formulation is carried out by analyzing their minimum inhibitory concentration (MIC) against F. oxysporum. Such study as conducted in the present invention indicates that clove essential oil is more potent (31.25 ppm) and provides consistent fungicidal effect compared to lemongrass oil (62.5 ppm). However, the combination of the two has been found to produce a synergistic effect at a ratio of 1:1 w/w against fungal wilt pathogen, F. oxysporum. Such synergistic effect not only to enhance their antifungal efficacy, but also makes the preparation of such biopesticide cost effective.

The present formulation further comprises an amphiphilic component (surfactants), preferably a combination of two surfactants (Sₘᵢₓ). Suitable surfactants can be selected from the group consisting of phospholipids, alkyl polyglucosides, sorbitan esters with fatty acids, polyalkyleneglycol ethers of fatty alcohols (e.g. lauryl-, stearyl-, cetyl-, or palmityl alcohol), and/or pegylated mono- and diesters of glycerol with fatty acids for the development of microemulsion formulation. The preferred Surfactant mixture (Sₘᵢₓ) includes castor oil ethoxylates 40 moles ethylene oxides (CoE-40) and polyoxyethylene sorbitan monolaurate or polysorbate 20 (Tween-20) in the range of 1:1, 6:4, 7:3 and 8:2. The amount of Sₘᵢₓ in the microemulsion composition ranges 5-20 wt. % which is relatively low surfactant content and in fact, one of the particular benefits of the present invention.

The hydrophilic bioactive component used in the continuous phase comprise an antifungal plant biomass aqueous extract chosen from edible oil cakes (for e.g. mustard cake, cotton seed cake, groundnut cake, sesame cake, linseed cake, coconut cake, olive cake, sunflower oil cake, palm oil cake), nonedible oil cakes (for e.g. jatropha cake, neem cake, castor cake, karanja cake, simorubha cake, tung cake) and herbs (for e.g. Allium sativum, Piper nigrum, Zingiber officinale, Piper longum, Ocimum sanctum, Curcuma longa, Cinnamomum zeylanicum, Piper longum. The said continuous phase may further comprise of distilled water in combination with one or more inert liquid glycols, such as glycerol, propylene glycol, pentylene glycol, and/or polyethylene glycol.

In a preferred embodiment, the uses mustard cake extract as bioactive ingredient in the continuous phase of the emulsion.

Mustard cake extract is prepared by mixing cake and water in 1:5 (w/v) ratios followed by soaking in water-bath for 2 hours at 100° C. To get cake free extract, the mixture is filtered through muslin cloth and further centrifuged at 10,000 rpm for 15 minutes at 28° C. to clarify the solution. The mustard cake extract obtained is considered as 100%. All ingredients are stirred at 750 rpm for 30-60 min to assure a stable and fine dispersion of oil particles in form of a microemulsion. Optionally, ultrasound treatment of the combined ingredients can be used to accelerate the formation of a homogeneous microemulsion.

In the present invention, the composition comprises a larger amount of hydrophilic continuous phase, that accounts for around 60-90 wt. % of total formulation, wherein, the aqueous extract of the hydrophilic plant biomass is around 18-57 wt % of total formulation or 25-75 wt % of continuous phase.

Usually, O/W microemulsion has distilled water as inert continuous phase. However, the present inventors have utilized the antifungal mustard cake aqueous extract in continuous phase. Such preparation of the antifungal mustard cake in continuous phase provides two major benefits. Firstly, it increases the shelf life to about 2 years at room temperature while such aqueous botanical extracts known to be highly susceptible to contamination having very short shelf-life (24-48 h). Secondly, these aqueous extracts, though cheaper, are weaker antifungal agents compared to essential oils, but when prepared in continuous phase, it enhances the overall potency of the microemulsion against Fusarium sp. induced wilt disease. The present inventors have thus found that except for one where 100% distilled water is replaced with mustard cake extract, all other formulations having 25-75 wt % of distilled water being replaced by mustard cake extract are more stable, effective and having a particle size of 20-100 nm.

An embodiment of the present invention provides an antifungal, oil-in-water microemulsion formulation comprising: a) 2.5-5 wt. % of a synergistic mixture of two lipophilic bioactive ingredients in dispersed phase; b) 18-57 wt. % of an aqueous extract of a hydrophilic bioactive ingredient in the continuous phase of distilled water; and c) 5-20 wt. % of amphiphilic surfactant.

In another embodiment, the present antifungal oil-in-water microemulsion formulation comprising a) 2.5-5 wt. % of a mixture clove oil and lemongrass oil at a ratio of 1:1 in dispersed phase; b) 18-57 wt. % of a mustard cake aqueous extract in continuous phase of distilled water; and c) 5-20 wt. % of castor oil ethoxylates 40 moles ethylene oxides and polyoxyethylene sorbitan monolaurate are present in a ratio selected from 1:1, 6.4, 7:3 or 8:2.

In a preferred embodiment of the present invention, a microemulsion formulation has been provided having 37.5 wt % mustard cake extract and 37.5 wt. % water (i.e. 1:1 ratio) have a particle size of 54.20 nm, with MIC value 4000 ppm. The microemulsion formulation without mustard cake extract shows less potency against F. oxysporum and inhibits 100% mycelia growth at 6000 ppm.

The microemulsion of the present invention may be prepared by any methods well known in the art. Such methods include condensation or low-energy emulsification methods (the system goes through low interfacial tensions during the emulsification process) or by application of high energy input during emulsification, the so-called dispersion methods (A. Forgiarini, J. Esquena, C. Gonza'lez, and C. Solans Langmuir 2001). To test the shelf life of the formulation, two formulations (with and without cake extract) are kept at 40° C. at 70% Relative Humidity (RH) and 4° C. for 15 days for their accelerated storage stability tests. After 15 days, no separation of phases (oil and water) have been observed, thus indicating shelf life of the formulation to be two years at room temperature.

The antifungal efficacy of both the formulations before and after storage has been determined. It is observed that the efficacy of microemulsion with cake extract in continuous phase remain almost intact (94.5% inhibition at 4000 ppm i.e. MIC value of 0 day), whereas, the microemulsion with water as continuous phase deteriorates in terms of efficacy and is capable of only 83.5% inhibition at 6000 ppm compared to 100% on 0 day. The use of mustard cake extract in the continuous phase of the formulation thus not only enhances the overall efficacy of the formulation, but also results in enhancing the shelf life.

A kinetic model is also developed to better understand the antifungal activity, especially when continuous phase is used as an active in a microemulsion formulation. The results demonstrate that present microemulsion composition comprising mustard cake in continuous phase is capable of killing fungal spores 1.33-7 times faster than those without them.

Further, the in vivo experimental studies for evaluating the antifungal efficacies of three concentrations of the current microemulsion formulation (MIC, IC90 and IC50) against—Fusarium sp. germination assay shows that the current ME formulation is non-phytotoxic to tomato seeds at all concentrations with germination % of 91-93%.

Another embodiment of the present invention provides a bio-pesticide comprising 1394 ppm to 4000 ppm amount of the oil-in-water microemulsion formulation developed in the present invention.

Pot studies conducted using such a bio-pesticide exhibited the antifungal efficacy of about 55-70% against wilt inducing fungus F. oxysporum. Specifically, among the two different treatments (seedling and soil), soil treatment has been found to be most effective as it reduces 68.42% wilt incidence at MIC followed by seedling treatment (59.17% reduction).

Therefore, the micro-emulsion formulation of the present invention that essentially comprises two opposite nature ingredients in two different phases of the emulsion i.e. lipophilic bioactive components in the dispersed phase and hydrophilic bioactive component in the continuous phase is advantageously capable of delivering antifungal active ingredients from both dispersed and continuous phases. Thus the currently developed formulation is highly effective even after harsh storage conditions and shows antifungal activity under both in vitro and in vivo conditions.

The present invention can be further described by way of non-limiting examples:

### EXAMPLES

### Example 1: Synergism of Clove and Lemongrass Oil Against F. oxysporum

Example 1 illustrates the quantitative effects of EOs used in the present microemulsion formulation comprising a mixture of clove oil and lemongrass oil in the dispersed phase, in terms of FIC (fractional inhibitory concentration) indices.

The FIC indices are calculated as FICA+FICB, where FICA and FICB are the minimum concentrations that inhibited the bacterial growth for EOs A (clove oil) and B (lemongrass oil), respectively. Thus, FICs are calculated as follows: FICA=(MIC combination/MICA alone) and FICB=(MICB combination/MICB alone). The results are interpreted as synergy (FIC<0.5), addition (0.5≤FIC≤1), indifference (1<FIC≤4) or antagonism (FIC>4) (Schelz at el., 2006).

TABLE 1

| | | | | | | FIC Index | |
|---|---|---|---|---|---|---|---|
| | | | | | | (FIC_{A} + | |
| SN | Parameters | MIC (ppm) | | FIC_{A} | FIC_{B} | FIC_{B}) | Remark |
| 1 | Clove oil(A) | 31.25 | (MIC_{A}) | — | — | | |
| 2 | Lemon grass oil(B) | 62.5 | (MIC_{B}) | — | — | | |
| 3 | Clove - | 3.90 | (MIC_{A/B}) | 0.125 | 0.25 | 0.375 | Synergism |
| | Lemongrass oil | 15.625 | (MIC_{B/A}) | | | | |

Results:

According to the data in table 1 above, the FICA+FICB value for the EOs used in the present formulation (clove oil and lemongrass oil) is found to be 0.375 (<0.5), hence it is concluded that the two EOs are synergistic to each other in terms of antifungal activity.

### Example 2: Preparation of Oil-in Water Microemulsion Containing EO Mixture (1:1 Ratio) in Dispersed Phase and Mustard Cake Extract in Continuous Phase

Example 2 illustrates the four different microemulsion compositions prepared in accordance with the present invention. These compositions are depicted in tables 2 to 7 below:

TABLE 2
Composition A

| | |
|---|---|
| Component | Weight % |

| | | |
|---|---|---|
| Active ingredients in | Clove + lemongrass oil | 5 |
| dispersed phase | | |
| Surfactant mixture (Sₘᵢₓ) | COE-40 | 14 |
| | Tween-20 | 6 |
| Hydrophilic component | Propylene glycol | 0 |
| | water | 75 |
| Total | | 100 |

TABLE 3
Composition B

| | |
|---|---|
| Component | Weight % |

| | | |
|---|---|---|
| Active ingredients in | Clove + lemongrass oil | 5 |
| dispersed phase | | |
| Surfactant mixture (Sₘᵢₓ) | COE-40 | 10.5 |
| | Tween-20 | 4.5 |
| Hydrophilic component | Propylene glycol | 5 |
| | water | 75 |
| Total | | 100 |

TABLE 4
Composition C

| Component | | Weight % |
|---|---|---|
| Active ingredients in | Clove + lemongrass oil | 5 |
| dispersed phase | | |
| Surfactant mixture (Sₘᵢₓ) | COE-40 | 10.5 |
| | Tween-20 | 4.5 |
| Hydrophilic component | Propylene glycol | 5 |
| | water | 56.25 |
| Active in continuous phase | Mustard cake extract | 18.75 |
| Total | | 100 |

TABLE 5
Composition D

| Component | | Weight % |
|---|---|---|
| Active ingredients in | Clove + lemongrass oil | 5 |
| dispersed phase | | |
| Surfactant mixture (Sₘᵢₓ) | COE-40 | 10.5 |
| | Tween-20 | 4.5 |
| Hydrophilic component | Propylene glycol | 5 |
| | water | 37.5 |
| Active in continuous phase | Mustard cake extract | 37.5 |
| Total | | 100 |

TABLE 6
Composition E

| Component | | Weight % |
|---|---|---|
| Active ingredients in | Clove + lemongrass oil | 5 |
| dispersed phase | | |
| Surfactant mixture (Sₘᵢₓ) | COE-40 | 10.5 |
| | Tween-20 | 4.5 |
| Hydrophilic component | Propylene glycol | 5 |
| | water | 18.75 |
| Active in continuous phase | Mustard cake extract | 56.25 |
| Total | | 100 |

TABLE 7
Composition F

| Component | | Weight % |
|---|---|---|
| Active ingredients in | Clove + lemongrass oil | 5 |
| dispersed phase | | |
| Surfactant mixture (Sₘᵢₓ) | COE-40 | 10.5 |
| | Tween-20 | 4.5 |
| Hydrophilic component | Propylene glycol | 5 |
| | Water | — |
| Active in continuous phase | Mustard cake extract | 75 |
| Total | | 100 |

All the above formulations are transparent or slightly opalescent microemulsions formed spontaneously upon mixing. After 15 days at 40° C. & 70% RH, these samples of the microemulsions are visually inspected, and no indication of physical instability is found.

### Example 3: In Vitro Bioefficacy of Microemulsion Compositions (B and D) Against Fusarium oxysporum (Before and after Accelerated Storage Stability Test)

Example 3 demonstrates the enhanced antifungal efficacy of the present microemulsion formulation by virtue of the presence of hydrophilic mustard cake aqueous extract in the continuous phase.

Procedure:

Microemulsions with different ratio of mustard cake extract are prepared and their MIC values against F. oxysporum are determined through poisoned food technique. PDA (Potato Dextrose Agar) (1000 ml) is poured into sterilized Petri dishes (90 mm diameter) and measured amount of microemulsion (for e.g. For 4000 ppm-0.4 g in 100 ml; and for 65000 ppm-0.65 g in 100 ml) is added to get the required concentrations.

The control sets are prepared using equal amounts of blank formulation (without active ingredients) in place of oil. A fungal disc (5 mm in diameter) of F. oxysporum, cut from the periphery of a five day-old culture using a cork borer, is inoculated aseptically into the centre of each Petri dish. The plates are sealed with polyethylene film and incubated at a temperature of 28+2° C. until the growth in the control plates reaches the edge of the plates. The plates are used in triplicate for each treatment. Percentage inhibition of the radial growth by different oils compared to control is calculated using below equation:

% Inhibition=(C−T)/C×100

where C is radial growth in control and T is radial growth in different concentrations of microemulsion.

Results:

It is found that the microemulsions with mustard cake extract in continuous phase are more toxic and renders better pathogenicity (MIC: 4000 ppm) compared to compositions without the extract (MIC: 6000 ppm).

Storage Study:

The critical role of mustard cake extract in continuous phase of the present formulation is further highlighted when two of the microemulsions developed i.e. Composition B (without mustard cake extract) and D (with 50% mustard cake extract) are kept at 40° C. at 70% RH for 15 days for their stability tests.

Results:

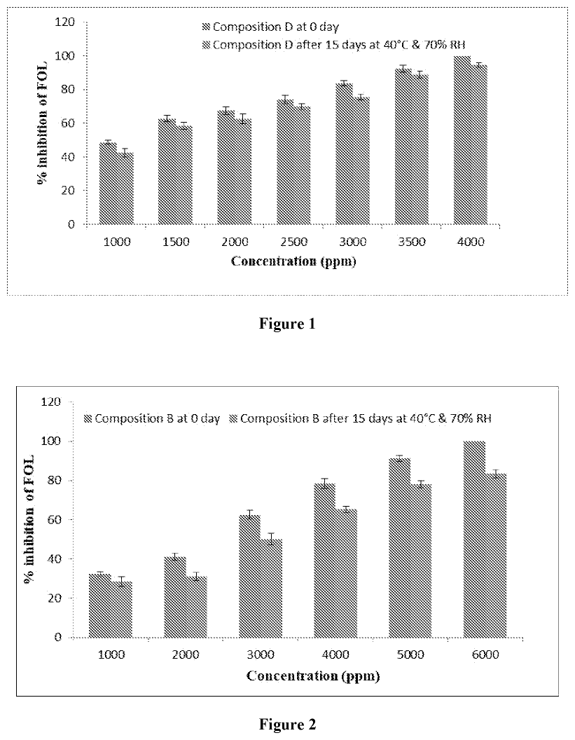

After 15 days, no separation of phases (oil and water) occurs, which is suggestive of the shelf life of the formulation to be two years at room temperature. However, the antifungal efficacy of composition B and D before and after storage are found to be very significantly different to each other. Further, it is evident from the above results read along with accompanying FIGS. 1-2 that the antifungal efficacy of composition D (FIG. 1) does not get affected (94.5% inhibition at MIC value of 0 day), whereas, composition B comparatively deteriorated in terms of efficacy and only 83.5% inhibition is observed at its MIC value i.e. 6000 ppm (FIG. 2).

Further, logistic growth kinetics is used to determine the rate of killing fungal spores by microemulsions with following logistic equation:

dyᵣ/dt=−dyᵥ/dt=kyᵥ(1−yₙ/yₘ) (1)

and integrated form of Logistic equation is:

yᵣ=yₘ/(1+((yₘ/yₒ)−1)e\hat{ }−kt), (2)

wherein, yᵥ is the percentage of viable spores, yᵣ represents the spore reduction (%), k is the growth rate constant of reduced spores, yₘ is the maximum possible spore reduction (%), yₒ is the initial spore reduction (%), minimum inhibitory concentration (MIC), time needed for fungicidal effect (t), maximum possible percentage of reduced spores (yₘ), initial percentage of reduced spores (y₀), growth rate constant of reduced spores (k) and coefficient of determination (R²).

Results:

The overall results obtained have been provided in table 8 below:

TABLE 8

| | MIC | t | yₘ | yₒ | k ×10² | |
|---|---|---|---|---|---|---|
| | (ppm) | (min) | (%) | (%) | (min⁻¹) | R² |
| Composi- | 6000 | 90 | 98.9 ± 1.28 | 22.1 ± 1.73 | 6.17 | 0.98 |
| tion B | | | | | | |
| Composi- | 4000 | 60 | 98.3 ± 1.49 | 28.3 ± 1.13 | 8.22 | 0.97 |
| tion D | | | | | | |

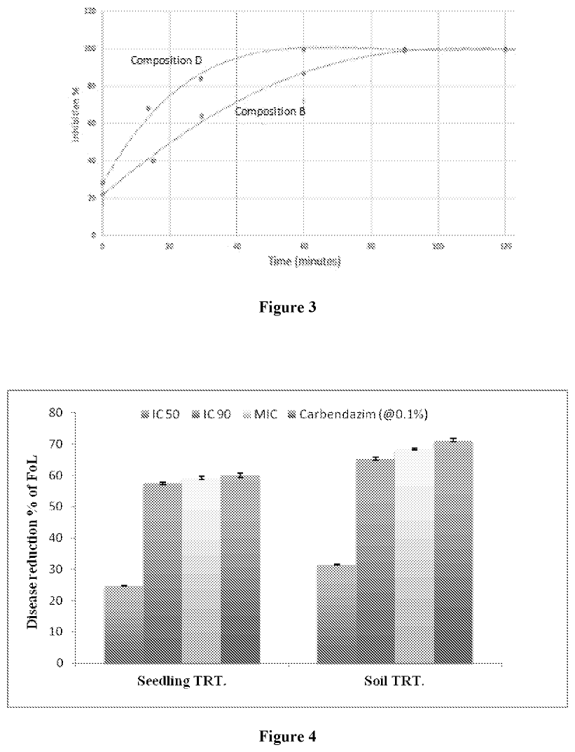

Further, FIG. 3 demonstrates F. oxysporum spore reduction (%) during time by using minimum fungicidal concentrations of composition B and composition D (b). The kinetic models thus reveal 1.33 times faster fungicidal activity of composition D compared to composition B, thus justifying the significance of using active in continuous phase of the present microemulsion formulation.

### Example 4: Preparation of a Comparative Oil-in Water Microemulsion Containing a Single EO in Dispersed Phase and Mustard Cake Extract in Continuous Phase

Example 4 illustrates a comparative microemulsion wherein the continuous phase comprises of only one oil i.e. clove oil, as depicted in table 9 below:

TABLE 9
Composition G

| | |
|---|---|
| Component | Weight % |

| | | |
|---|---|---|
| Active ingredients in | Clove oil | 2.5 |
| dispersed phase | | |
| Surfactant mixture (Sₘᵢₓ) | COE-40 | 14 |
| | Tween-20 | 6 |
| Hydrophilic component | Propylene glycol | 10.5 |
| | Water | 38.5 |
| Active in continuous phase | Mustard cake extract | 38.5 |
| Total | | 100 |

The above formulation is transparent microemulsions formed spontaneously upon mixing.

After 15 days at 40° C. & 70% RH, this sample of the microemulsions is visually inspected, and no indication of physical instability is found.

Further, the antifungal efficacy/minimum inhibitory concentration (MIC) of composition G is found to be 6000 ppm. The MIC value thus obtained for composition G shows lesser efficacy than that of composition D (currently developed composition having MIC at 4000 ppm), but is at par with composition B (without bioactive ingredient in continuous phase; MIC at 6000 ppm). This loss of efficacy is attributed towards the presence of single/lower amount of EO in composition G which equates to the MIC of composition B that is devoid of any bioactive ingredient in continuous phase. Whereas, the higher efficacy of current composition D is due to the presence of both these essential features together i.e. a synergistic mixture of two EOs in dispersed phase along with presence of an aqueous extract of a hydrophilic bioactive ingredient in continuous phase.

### Example 5: Effect of Microemulsion (ME) Formulation (Composition D) on Tomato Seed Germination and Incidence of Fusarium Wilt in Tomato Crops

Example 5 illustrates the Germination assay conducted on current ME formulation.

Procedure:

Germination plastic tray are filled with soilless growth medium (cocopeat:vermiculite:perlite=3:1:1). Tomato seeds (variety PUSA Ruby) are sterilized by 4% sodium hypochlorite solution by keeping the seeds in the solution for 2 minutes and then washed with distilled water 3 times and are soaked in tissue paper. Treatment consists of selected microemulsion (composition D) formulation with different concentrations (MIC, MIC₉₀ and MIC₅₀). Seeds are then dipped in different treatments for 30 min. 2 types of control are taken, positive control (without F. oxysporum, healthy soil) and negative control (with F. oxysporum, unhealthy soil). Experiment is conducted for 8 days and repeated thrice. Seedling Vigor is the sum total of those properties of the seed which determine the level of activity and performance of the seed or seed lot during germination and seedling emergence. It is measured by two formulas given below:

SVI_{L}=Germination %×Seedling Length (cm)

SVI_{W}=Germination %×Seedling Weight (g)

Results:

The data reveals that the present microemulsion formulation treatments do not affect the germination of tomato seeds even in the presence of wilt fungus and thus produce a healthy seedling indicated by high seedling vigour index as provided in table 10 below:

TABLE 10

| | | | | Dry | | |
|---|---|---|---|---|---|---|
| | | Germination | Seedling | Seedling | | |
| | Concentration | percentage | length | Weight | | |
| S. no | (ppm) | (%) | (cm) | (g) | SVI_{L} | SVI_{W} |
| 1 | MIC₅₀ | 92.3 | 18.23 ± 1.10 | 9.10 ± 0.52 | 1682.62 | 839.93 |
| 2 | MIC | 91.9 | 28.06 ± 1.89 | 21.66 ± 0.83 | 2578.71 | 1990.55 |
| 3 | MIC₉₀ | 91.6 | 28.73 ± 1.80 | 21.80 ± 0.69 | 2631.66 | 1996.88 |
| 4 | Positive control | 93.2 | 30.36 ± 0.55 | 22.10 ± 0.10 | 2829.55 | 2059.72 |
| 5 | Negative control | 84.5 | 17.43 ± 0.86 | 7.33 ± 0.15 | 1533.84 | 645.04 |

Wilt Incidence Study:

For wilt incidence study, seeds, seedlings and soil are treated with above mentioned three concentrations of microemulsion formulation. In brief, soil is autoclaved and artificially inoculated with Fusarium spores (@ 2.6×10⁵ spores/g soil). Seeds are treated with microemulsion formulations by the method used for germination study, but herein, seeds are sowed directly into 1 kg diseased pot. For seedling treatment, healthy eight-leaf staged seedlings of tomato are treated with three respective concentrations of microemulsion while in case of soil treatment; soil of pot is treated @ 5 ml per 150 cc soil. Healthy and untreated seedlings are taken as control. Each treatment has 5 replicates and all the pots are kept in the net house in Micro model, IITD for 45 days. Carbendazim (@0.1%) is taken as chemical control. For accessing the disease progression in the tomato plant, following grading system is used. Symptoms like yellowing of leaves, wilting of plant, height and weight of plant are examined and given a grade by comparing with the control having maximum diseases infection.

Disease progresses in microemulsion treated tomato plants are compared to those in the untreated plants, and demonstrated in terms of Area Under Disease Progression curve (AUDPC). Area under the disease progress curve (AUDPC) is a method to calculate the percentage inhibition of wilt disease and is calculated as:

AUDPC=Σ[(Ri+1+Ri)/2][ti+1−ti],

R=disease rating at the ith observation

ti=time (days) since previous ratings at the ith observation,

n=total number of observations.

Results:

Relative AUDPC (%) is obtained for pesticide-treated plant by comparison with the AUDPC data of the non-treated plant as 100% (as demonstrated graphically by FIG. 4). The best protection in autumn season is observed in soil treatment by microemulsion at MIC dose (68.42%) followed by seedling treatment (59.17%). The data has been depicted in table 11 below:

TABLE 11

Disease reduction % of FoL

| | Micro emulsion @ | | | Chemical (carbendazim) |
|---|---|---|---|---|
| Treatment | IC 50 | IC 90 | MIC | @ 0.1% |
| Seedling | 24.73 | 57.39 | 59.17 | 60.02 |
| Soil | 31.45 | 65.26 | 68.42 | 71.24 |

1: An antifungal oil-in-water microemulsion formulation comprising:
a) 2.5-5 wt. % of a mixture of lipophilic bioactive ingredients in dispersed phase;
b) 18-57 wt. % of a plant biomass aqueous extract in continuous phase of distilled water; and
c) 5-20 wt. % of an amphiphilic surfactant.

2: The microemulsion formulation as claimed in claim 1, wherein the lipophilic bioactive ingredient is selected from a group of essential oils consisting of clove oil, lemon grass oil, mint oil, thyme oil, eucalyptus oil, ginger oil, sesame oil, basil oil, geranium oil, rosemary oil, lavender oil, marigold oil and combinations thereof.

3: The microemulsion formulation as claimed in claim 1, wherein the mixture of lipophilic bioactive ingredients preferably comprises two essential oils in a concentration ratio of 1:1.

4: The microemulsion formulation as claimed in claim 3, wherein the essential oils are clove oil and lemongrass oil.

5: The microemulsion formulation as claimed in claim 4 having an antifungal activity (FIC Index) of 0.25-0.375.

6: The microemulsion formulation as claimed in claim 1, wherein the plant biomass aqueous extract in continuous phase is selected from edible oil cakes, non-edible oil cakes or herbs.

7: The microemulsion formulation as claimed in claim 6, wherein edible oil cakes are selected from mustard cake, cotton seed cake, groundnut cake, sesame cake, linseed cake, coconut cake, olive cake, sunflower oil cake or palm oil cake.

8: The microemulsion formulation as claimed in claim 6, wherein non-edible oil cakes are selected from jatropha cake, neem cake, castor cake, karanja cake, simorubha cake or tung cake.

9: The microemulsion formulation as claimed in claim 6 wherein herbs are selected from Allium sativum, Piper nigrum, Zingiber officinale, Piper longum, Ocimum sanctum, Curcuma longa, Cinnamomum zeylanicum, or Piper longum.

10: The microemulsion formulation as claimed in claim 7, wherein the edible oil cake is preferably mustard cake aqueous extract.

11: The microemulsion formulation as claimed in claim 10, wherein the mustard cake aqueous extract is present in an amount of 25-75 wt. % of continuous phase.

12: The microemulsion formulation as claimed in claim 1, wherein the amphiphilic surfactant is selected from a group consisting of phospholipids, alkyl polyglucosides, sorbitan fatty esters, polyalkyleneglycol ethers of fatty alcohols, pegylated monoester of fatty acid glycerols, pegylated diesters of fatty acid glycerols, and combinations thereof.

13: The microemulsion formulation as claimed in claim 12, wherein the amphiphilic surfactant is preferably a combination of castor oil ethoxylates 40 moles ethylene oxides and polyoxyethylene sorbitan monolaurate.

14: The microemulsion formulation as claimed in claim 13, wherein the castor oil ethoxylates 40 moles ethylene oxides and polyoxyethylene sorbitan monolaurate are present in a ratio selected from 1:1, 6.4, 7:3 or 8:2.

15: An antifungal oil-in-water microemulsion formulation comprising a) 2.5-5 wt. % of a mixture clove oil and lemongrass oil at a ratio of 1:1 in dispersed phase; b) 18-57 wt. % of a mustard cake aqueous extract in continuous phase of distilled water; and c) 5-20 wt. % of castor oil ethoxylates 40 moles ethylene oxides and polyoxyethylene sorbitan monolaurate at ratio selected from 1:1, 6.4, 7:3 or 8:2.

16: The microemulsion formulation as claimed in claim 1, wherein the formulation has a shelf life of two years at room temperature.

17: The microemulsion formulation as claimed in claim 1 having 1.33-7 times faster fungicidal activity against wilt inducing fungus F. oxysporum.

18: The microemulsion formulation as claimed in claim 1 having a minimum inhibitory concentration (MIC) value at 4000 ppm against wilt inducing fungus F. oxysporum.

19: The microemulsion formulation as claimed in claim 1 having a germination % of tomato seeds ranging between 91-93%.

20: The microemulsion formulation as claimed in claim 1 has a particle size of 20-100 nm.

21: The microemulsion formulation as claimed in claim 1, wherein the formulation is non-phytotoxic.

22: A fungicidal composition comprising 1394 ppm to 4000 ppm amount of the oil-in-water microemulsion formulation as claimed in claim 1.

23: The fungicidal composition as claimed in claim 22, wherein the formulation provides an antifungal efficacy of 55-70% against wilt inducing fungus F. oxysporum.
